(19) United States
(12) Patent Application Publication
(10) Pub. No.: US 2015/0254709 A1
(43) Pub. Date: Sep. 10, 2015

(54) System and Method for Attributing Engagement Score Over a Channel

(71) Applicant: IgnitionOne, Inc., New York, NY (US)

(72) Inventors: Eric Carlyle, College Park, GA (US); Florian Grouffal, Levallois-Perret (FR); William Dexter Jones, Decatur, GA (US)

(21) Appl. No.: 14/721,177

(22) Filed: May 26, 2015

Related U.S. Application Data
(63) Continuation-in-part of application No. 14/178,708, filed on Feb. 12, 2014.
(60) Provisional application No. 61/825,784, filed on May 21, 2013.

(51) Int. Cl. G06Q 30/02

(52) U.S. Cl. CPC G06Q 30/0246

(57) ABSTRACT

A scoring probability system for determining the probability of a user to convert an action based upon a single score related to that user. The scoring probability system provides attribution to each channel responsible for leading to a conversion based upon the single score.

### CLAIM OF PRIORITY

This application claims priority in part from U.S. patent application Ser. No. 14/178,708 filed on Feb. 12, 2014, which claims priority from U.S. Provisional Patent Application No. 61/825,784 filed on May 21, 2013, both of which are relied upon and incorporated herein in their entirety by reference.

### BACKGROUND OF THE INVENTION

1. Technical Field

The present invention is in the technical field of online conversion, visitor profiling and visitor segmenting. In addition, the present invention is in the technical field of predicting behavior that can result in conversions online, and that of customizing the content of distributed messages to the particular interest of an individual user, and/or his position in the buying process. Further, the present invention is in the technical field of conversion attribution based on the behavior of each exposure that leads to a conversion.

2. Related Art

As more environments, including digital environments, are becoming more complex, individuals are turning towards various forms of technology for assistance. The same is true for the digital marketing environment. All types of technology support are utilized in the various areas of digital marketing, including, but not limited to, search marketing, display marketing, online advertisement, lead generation, voucher distribution, content personalization and the like. However, there is not a single technology designed to operate across the various areas of digital marketing in order to assist individuals to reach intelligent decisions in order to increase a predefined action (e.g., conversions, downloads, and the like).

Therefore, there is a need for a system or method to predict the probability of a particular user performing a certain action using a score driven approach.

Along the same lines, no system exists that can track media attribution across these areas of marketing. Media attribution is the process of identifying a set of user media exposures (clicks or views) that contribute in some manner to a desired outcome, typically referred to as a conversion, and then assigning a value of the desired outcome to each of these media exposures. Marketing attribution provides a level of understanding of what combination of exposures influence individuals to engage a desired behavior.

Visibility into what influences consumers, when and to what extent, allows marketers to optimize media spend for conversions and compare the value of different marketing channels, including paid and organic search, email, social media, affiliate marketing, display ads, partners and more. Understanding the entire conversion path across the whole marketing mix eliminates the accuracy challenge of analyzing data from channels in isolation. Typically, attribution data is used by marketers to plan future ad campaigns by analyzing which media placements were the most cost-effective as determined by metrics such as effective cost per action.

While multiple attribution models are currently used, each one has drawbacks in correctly identifying and assigning attribution. Single source attribution model assigns all the credit to one exposure, such as the last or first click or view. Single source attribution is the most common attribution model, but it is not very accurate as a result to fail for account of all contributing factors that led to the desired outcome. Fractional attribution models, including equal weight, linear, logarithmic, and U-curve, have tried to address some of the shortcomings of the single source models by taking into account all of the parts of the conversion path. However, these models don't accurately assign attribution to the correct portions of the path. Equal weight models give the same amount of credit to each channel along the conversion path. Likewise, the U-curve models assign the credit to the first and last touch, discounting what happens in the middle of the conversion path.

Algorithmic or probabilistic attribution models are a step in the right direction, assigning conversion credit across all touch points preceding the conversion. Such models use automated computation to decide where credit is due. For example, algorithmic attribution models start at the event level and analyze both the converting and non-converting paths across the different channels. Weights are then combined by grouping such as placement, site, or channel, as reporting granularity is decreased, allowing the data to point out the hidden correlations and insights within marketing efforts.

However, none of these models attribute conversion based on the behavior generated onsite by each media exposure. Therefore, there is a need for system or method that attributes conversion on such behavior for each media exposure. Further, no one has tried to base such attribution on predictive systems. Therefore, there is a need for a system or method which assigns a conversion based upon a predictive system of a particular user performing a certain action using a score driven approach.

### SUMMARY OF INVENTION

The present invention is a system and method for determining the probability of a particular user converting/committing a certain action in a single score. In an aspect, the score can represent the probability of the individual to convert. In another aspect, the score can be identified as, but not limited to, an engagement score, measuring the level of interest in a product or a brand. In an aspect, the score based system can be used to segment and target visitors for lead generation, to adjust bids on real time bidding (RTB), to personalize content on websites, emails and other messages, to measure, evaluate and optimize (online) media campaigns, and bidding strategies, to send push notifications to online visitors, to enrich external environments (like CRM systems) with profile data.

In an aspect, the system can utilize an automated process configured to happen in real-time on a visitor individual level. In an aspect, the system can be used to measure, analyze and evaluate the user engagement on a website. These metrics can be used to optimize media budgets towards brand engagement and conversion probability.

These and other objects and advantages of the invention will become apparent from the following detailed description of the preferred embodiment of the invention.

Both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention, and together with the description serve to explain the principles of the invention.

### BRIEF DESCRIPTION OF THE DRAWINGS

FIG. 1 is a schematic representation of a scoring probability system according to an aspect.

FIG. 2 is a block diagram of an internet enabled device of the system of FIG. 1 according to an aspect.

FIG. 3 is a block diagram of the vendor server of FIG. 1 according to an aspect.

FIG. 4 is a block diagram of the scoring probability server of FIG. 1.

FIG. 5 is a block diagram of components of the scoring probability server of FIG. 4.

FIG. 6 is a schematic flow diagram of a method performed by the system of FIG. 1.

FIG. 7 is a flow diagram of a method performed by the system of FIG. 1.

FIG. 8 is a flow diagram of a method performed by the system of FIG. 1.

FIGS. 9-10 are graphs comparing histograms to a kernel density estimator according to an aspect.

FIG. 11 is a graph comparing the results from using the system of FIG. 1 compared to older systems.

FIG. 12 is a Gains chart according to an aspect.

FIG. 13 are score density plots according to an aspect.

FIG. 14 is a representation of scores per session resulting in a conversion by a user generated by the scoring probability server of FIG. 1 according to an aspect.

FIG. 15 is a block diagram of components of an attribution profile according to an aspect.

### DETAILED DESCRIPTION OF THE EMBODIMENTS

The present invention will now be described more fully hereinafter with reference to the accompanying drawings, which are intended to be read in conjunction with this detailed description, the summary, and any preferred and/or particular embodiments specifically discussed or otherwise disclosed. This invention may, however, be embodied in many different forms and should not be construed as limited to the embodiments set forth herein. Instead, these embodiments are provided by way of illustration only and so that this disclosure will be thorough, complete and will fully convey the full scope of the invention to those skilled in the art.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. In addition, the present methods and systems may be implemented by centrally located servers, remote located servers, or cloud services. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, computers and components found in cloud services, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The methods and systems that have been introduced above, and discussed in further detail below, have been and will be described as comprised of units. One skilled in the art will appreciate that this is a functional description and that the respective functions can be performed by software, hardware, or a combination of software and hardware. A unit can be software, hardware, or a combination of software and hardware. In one exemplary aspect, the units can comprise a computer. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, cloud services, mobile devices (e.g., smart phones, tablets, and the like) and multiprocessor systems. Additional examples comprise set top boxes, programmable consumer electronics, network PCs, minicomputers, mainframe computers, enterprise servers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc., that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

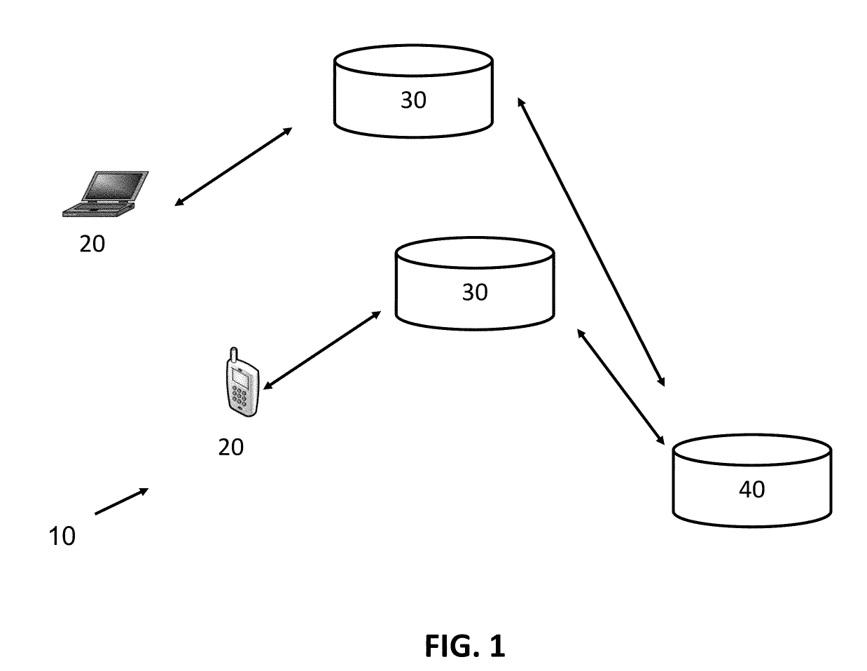

FIG. 1 illustrates a scoring probability system 10 according to an aspect of the present invention. As shown in FIG. 1, the scoring probability system 10 includes a plurality of internet enabled devices 20 that are configured for use by various different users. The internet enabled devices 20 can communicate with various vendor servers 30. The vendor servers 30 can communicate with a scoring probability server 40. The vendor servers 30, based upon information related to the user of the internet enabled device 20, calls upon the scoring probability server 40 to predict whether or not the user of the internet enabled device 20 will perform a certain action or not. In addition, the scoring probability server 40 is also called upon by the vendor servers 30 to assign a proportion of the score to each marketing exposure in a converting path, discussed in more detail below.

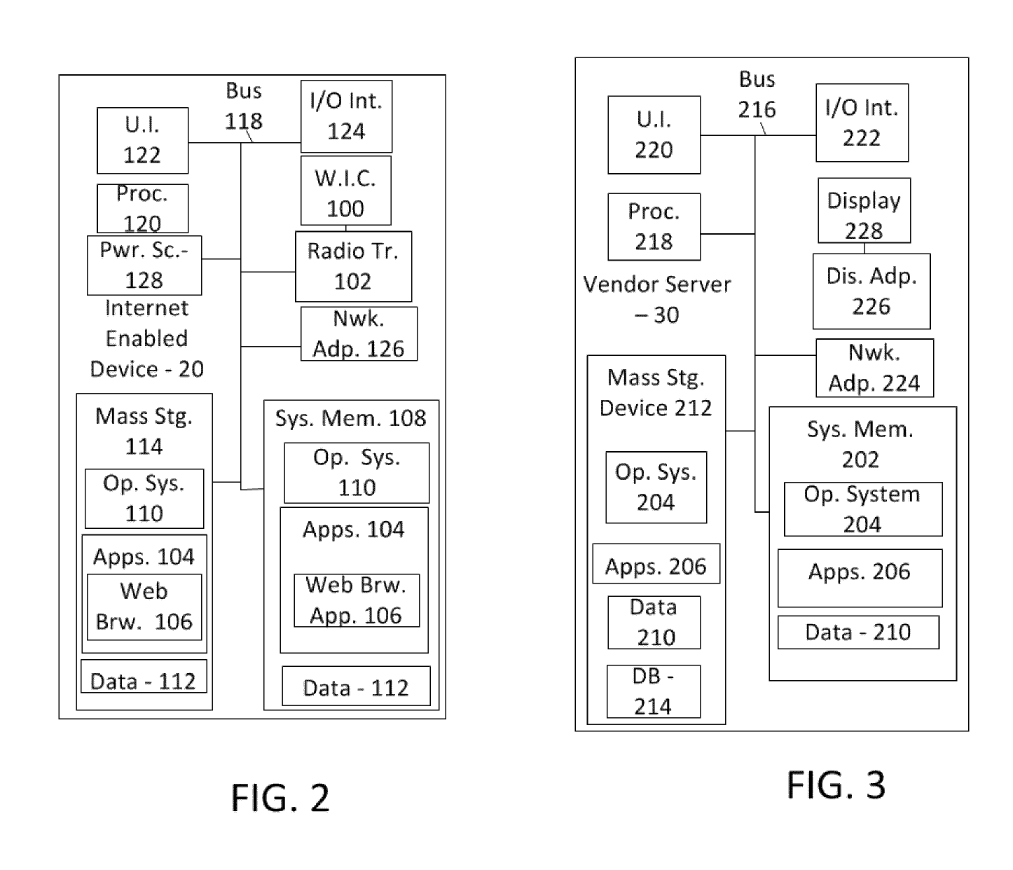

The internet enabled devices 20 can include, but are not limited to, laptop computers, tablets, smart phones, PDA's, hand held computers, and the like. According to an aspect, as shown in FIG. 2, the internet enable devices 20 include a combination wireless interface controller 100 and radio transceiver 102. The wireless interface controller (“W.I. Cont.”) 100 is configured to control the operation of the radio transceiver 102, including the connections of the radio transceiver 102, as well as the receiving and sending of information from the vendor servers 30 and scoring probability server 40.

The radio transceiver 102 may communicate on a wide range of public frequencies, including, but not limited to, frequency bands 2.4 GHz and/or 5 GHz-5.8 GHz. In addition, the radio transceiver 102, with the assistance of the wireless interface controller 100, may also utilize a variety of public protocols. For example, in some embodiments of the present invention, the combination wireless interface controller 100 and radio transceiver 102 may operate on various existing and proposed IEEE wireless protocols, including, but not limited to, IEEE 802.11b/g/n/a/ac, with maximum theoretical data transfer rates/throughput of 11 Mbps/54 Mbps/600 Mbps/54 MBps/1 GBps respectively. In an aspect, the radio transceiver 102 can include a wireless cellular modem 102 configured to communicate on cellular networks. The cellular networks can include, but are not limited to, GPRS, GSM, UMTS, EDGE, HSPA, CDMA2000, EVDO Rev 0, EVDO Rev A, HSPA+, and WiMAX, LTE.

In an aspect, the internet enabled devices 20 are configured to communicate with other devices over various networks. In an aspect, the internet enabled devices 20 operates in a networked environment using logical connections, including, but not limited to, local area network (LAN) and a general wide area network (WAN), and the internet. Such network connections can be through a network adapter 126. A network adapter 126 can be implemented in both wired and wireless environments. Such networking environments are conventional and commonplace in offices, enterprise-wide computer networks, intranets, cellular networks and the Internet.

The internet enable devices 20 may have one or more software applications 104, including a web browser application 106. The internet enabled device 20 includes system memory 108, which can store the various applications 104, including the web browser application 106, as well as the operating system 110. The system memory 108 may also include data 112 accessible by the various software applications. The system memory 108 can include random access memory (RAM) or read only memory (ROM). Data 112 stored on the internet enabled device 20 may be any type of retrievable data. The data may be stored in a wide variety of databases, including relational databases, including, but not limited to, Microsoft Access and SQL Server, MySQL, INGRES, DB2, INFORMIX, Oracle, PostgreSQL, Sybase 11, Linux data storage means, and the like.

The internet enabled device 20 can include a variety of other computer readable media, including a storage device 114. The storage device 114 can be used for storing computer code, computer readable instructions, program modules, and other data 112 for the internet enabled device 20, and the storage device 114 can be used to back up or alternatively to run the operating system 110 and/or other applications 104, including the web browser application 106. The storage device 114 may include a hard disk, various magnetic storage devices such as magnetic cassettes or disks, solid-state flash drives, or other optical storage, random access memories, and the like.

The internet enabled device 20 may include a system bus 118 that connects various components of the internet enabled device 20 to the system memory 108 and to the storage device 114, as well as to each other. Other components of the internet enabled device 20 may include one or more processors or processing units 120, a user interface 122, and one or more input/output interfaces 124. A user can interact with the internet enabled devices 20 through one or more input devices (not shown), which include, but are not limited to, a keyboard, a mouse, a touch-screen, a microphone, a scanner, a joystick, and the like, via the user interface 122.

In addition, the internet enabled device 20 includes a network adapter 126. In addition, the internet enabled device 20 can include a power source 128, including, but not limited to, a battery or an external power source.

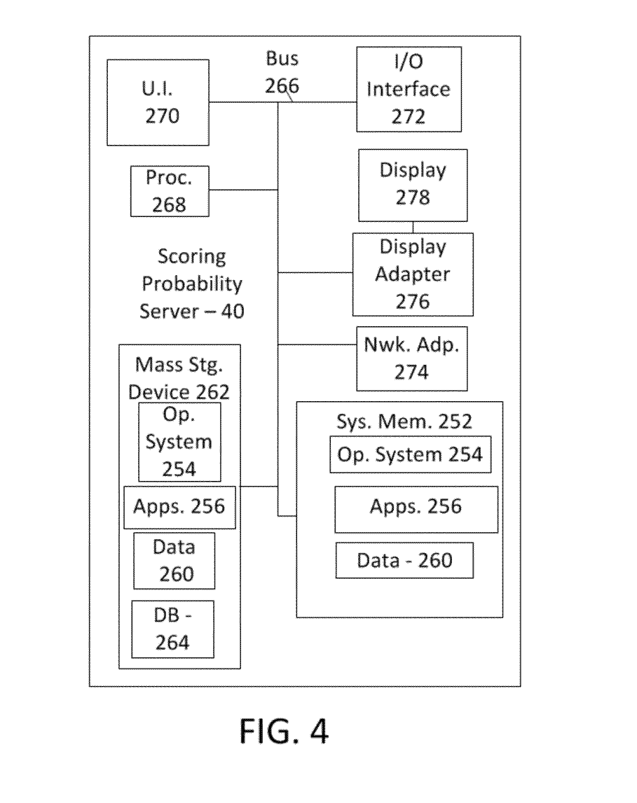

As shown in FIG. 1, the scoring probability system 10 can include more than one vendor servers 30 in addition to the scoring probability server 40. FIG. 3 illustrates a vendor server 30 according to an aspect. The vendor server 30 may have several applications 206, discussed in more detail below. In general, the vendor server 30 applications 206 may utilize elements and/or modules of several nodes or servers. In any event, the vendor servers 30 should be construed as inclusive of multiple modules, software applications, servers and other components that are separate from the internet enabled devices 20 and scoring probability server 40.

The vendor servers 30 can include system memory 202, which stores the operating system 204 and various software applications 206. The vendor servers 30 may also include data 210 that is accessible by the software applications 206. The vendor servers 30 may include a mass storage device 212. The mass storage device 212 can be used for storing computer code, computer readable instructions, program modules, various databases 214, and other data for the vendor servers 30. The mass storage device 212 can be used to back up or alternatively to run the operating system 204 and/or other software applications 206. The mass storage device 212 may include a hard disk, various magnetic storage devices such as magnetic cassettes or disks, solid state-flash drives, CD-ROM, DVDs or other optical storage, random access memories, and the like.

The vendor servers 30 may include a system bus 216 that connects various components of the vendor servers 30 to the system memory 202 and to the mass storage device 212, as well as to each other. In an aspect, the mass storage device 212 can be found on the same vendor server 30. In another aspect, the mass storage device 212 can comprise multiple mass storage devices 212 that are found separate from the vendor server 30. However, in such aspects the vendor servers 30 can be provided access.

Other components of the vendor servers 30 may include one or more processors or processing units 218, a user interface 220, an input/output interface 222, and a network adapter 224 that is configured to communicate with other devices, including, but not limited to, servers associated with recommendation tracking systems (discussed in more detail below), internet enabled devices 20, other servers, and the like. The network adapter 224 can communicate over various networks. In addition, the vendor servers 30 may include a display adapter 226 that communicates with a display device 228, such as a computer monitor and other devices that present images and text in various formats. A system administrator can interact with the vendor servers 30 through one or more input devices (not shown), which include, but are not limited to, a keyboard, a mouse, a touch-screen, a microphone, a scanner, a joystick, and the like, via the user interface 220.

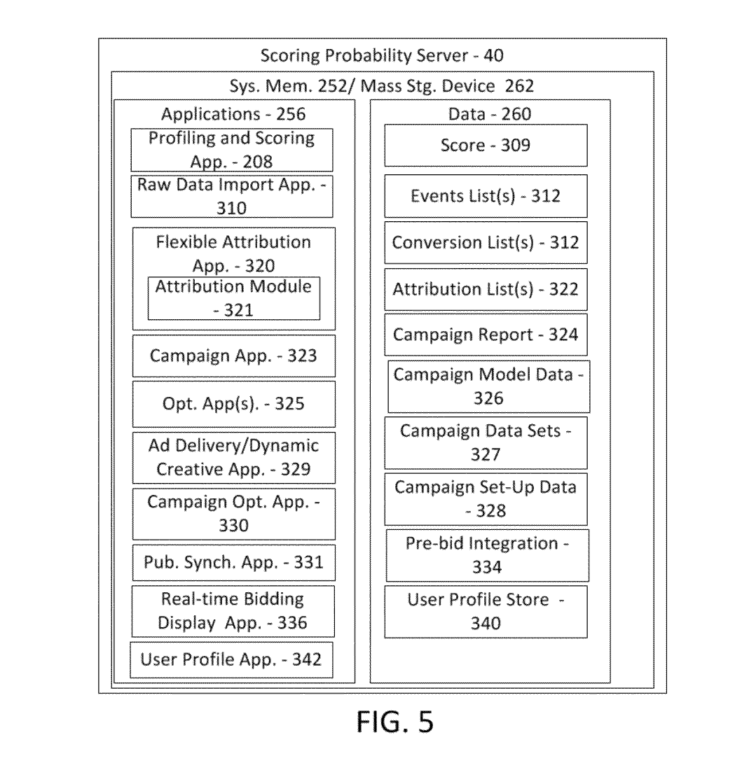

FIG. 4 illustrates a scoring probability server 40 according to an aspect. The scoring probability server 40 may have several applications 256, discussed in more detail below. In general, the probability scoring server 40 and its applications 256 may utilize elements and/or modules of several nodes or servers. In any event, the scoring probability server 40 should be construed as inclusive of multiple modules, software applications, servers and other components that are separate from the internet enabled devices 20 and the vendor servers 30.

The scoring probability server 40 can include system memory 252, which stores the operating system 254 and various software applications 256. The scoring probability server 40 may also include data 260 that is accessible by the software applications 256. The scoring probability server 40 may include a mass storage device 252. The mass storage device 262 can be used for storing computer code, computer readable instructions, program modules, various databases 264, and other data for the scoring probability server 40. The mass storage device 262 can be used to back up or alternatively to run the operating system 254 and/or other software applications 256. The mass storage device 262 may include a hard disk, various magnetic storage devices such as magnetic cassettes or disks, solid state-flash drives, CD-ROM, DVDs or other optical storage, random access memories, and the like.

The scoring probability server 40 may include a system bus 266 that connects various components of the scoring probability server 40 to the system memory 252 and to the mass storage device 262, as well as to each other. In an aspect, the mass storage device 262 can be found on the same scoring probability server 40. In another aspect, the mass storage device 262 can comprise multiple mass storage devices 262 that are found separate from the scoring probability server 40. However, in such aspects the scoring probability server 40 can be provided access.

Other components of the scoring probability server 40 may include one or more processors or processing units 268, a user interface 270, an input/output interface 272, and a network adapter 274 that is configured to communicate with other devices, including, but not limited to, servers associated with the recommendation tracking system(s), discussed in more detail below, the internet enabled devices, other servers, and the like. The network adapter 274 can communicate over various networks. In addition, the servers may include a display adapter 276 that communicates with a display device 278, such as a computer monitor and other devices that present images and text in various formats. A system administrator can interact with the servers through one or more input devices (not shown), which include, but are not limited to, a keyboard, a mouse, a touch-screen, a microphone, a scanner, a joystick, and the like, via the user interface 270.

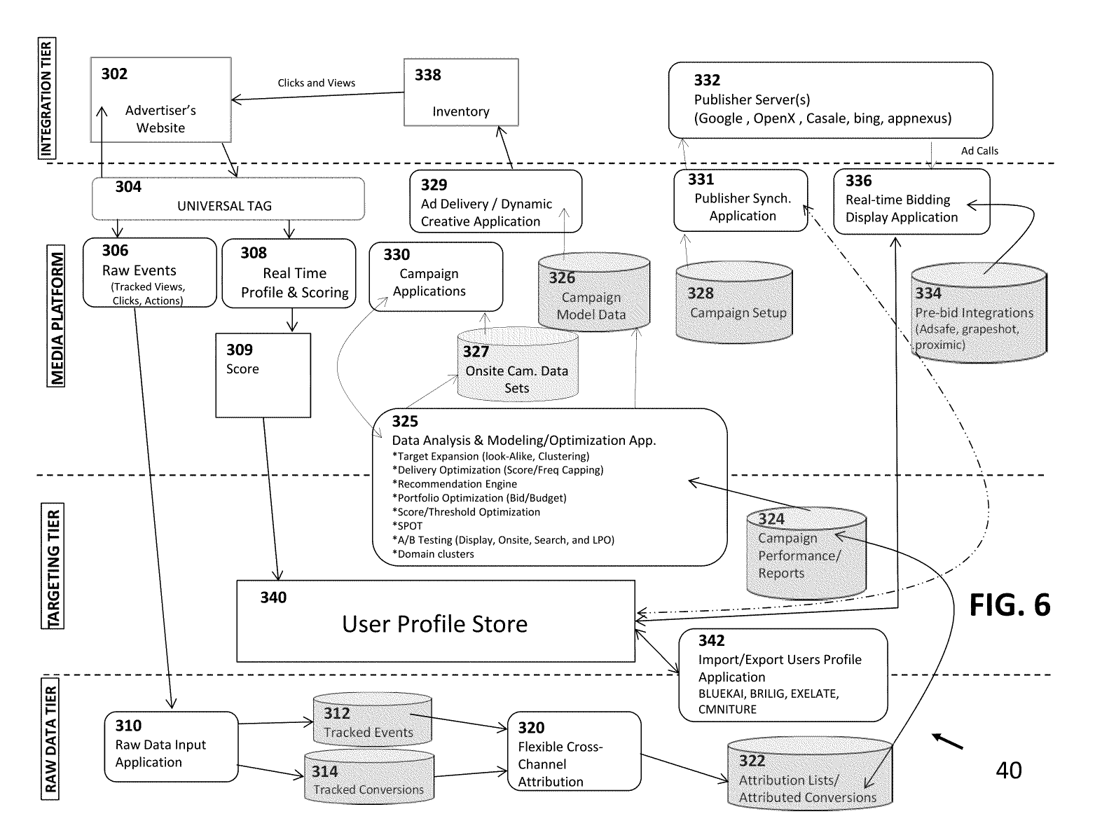

FIGS. 5-7 illustrate the various applications of the scoring probability server 40 and the steps performed by the applications according to an aspect. The probability server 40 is configured to obtain data about particular users, associated with internet enabled devices 20, who visit advertiser websites 302. These websites 302 are associated with a vendor server 30. Each of the websites 302 operated by the vendors 30 who utilize the functions of the probability server 40 include a universal tag 304. The universal tag 304 can be generated by tag generating modules and/or applications known in the art, which can be found on vendor server 30 or the probability scoring vendor 40. In an aspect, the universal tag 304 is utilized to identify specific hosts of websites and the various web pages associated with the website 302. In an aspect, when activated, the universal tag 304 calls upon the various applications 256 of the scoring probability server 40, discussed in more detail below.

In an aspect, the scoring probability server 40 is configured to capture and track actions of the users of the internet enabled devices 20 who visit the websites 302 associated with the vendor servers 30 (shown at step 306). The scoring probability server 40 is also configured to develop and maintain a score 309 for each user associated with the internet enabled devices for each client associated with the vendor server 30 (step 308). The score 309 is configured to indicate the probability that a user will carry out a specific action. For example, the score 309 can be used to indicate the propensity of the user to buy an item advertised by the vendor server 30. Other examples include, but are not limited to, a site/brand engagement score, a level of interest score, a conversion score, and/or a product interest score. In an aspect, a level of interest score would quantify the intensity of the user in general (product interest score), in a specific product (product interest score) or in a service. Multiple scores could be combined to constitute a customer live-cycle. Further, portions of the score 309 can be allocated to a specific session on the conversion path, discussed in detail below.

In an aspect, the scoring probability server 40 can utilize a real-time profiling and scoring application 208 to generate the score 309. In an aspect, the real-time profiling and scoring application 208 is configured to parse out segment interests (i.e., measured activity in the aspect of interest), tie such segment interests to an individual (user of the internet enabled device 20) and maintain a score per segment identified for each client (i.e., vendor server 30), and maintain a user profile for the individual (user of the internet enabled device 20), including the score, as well as other client defined events, discussed in more detail below.

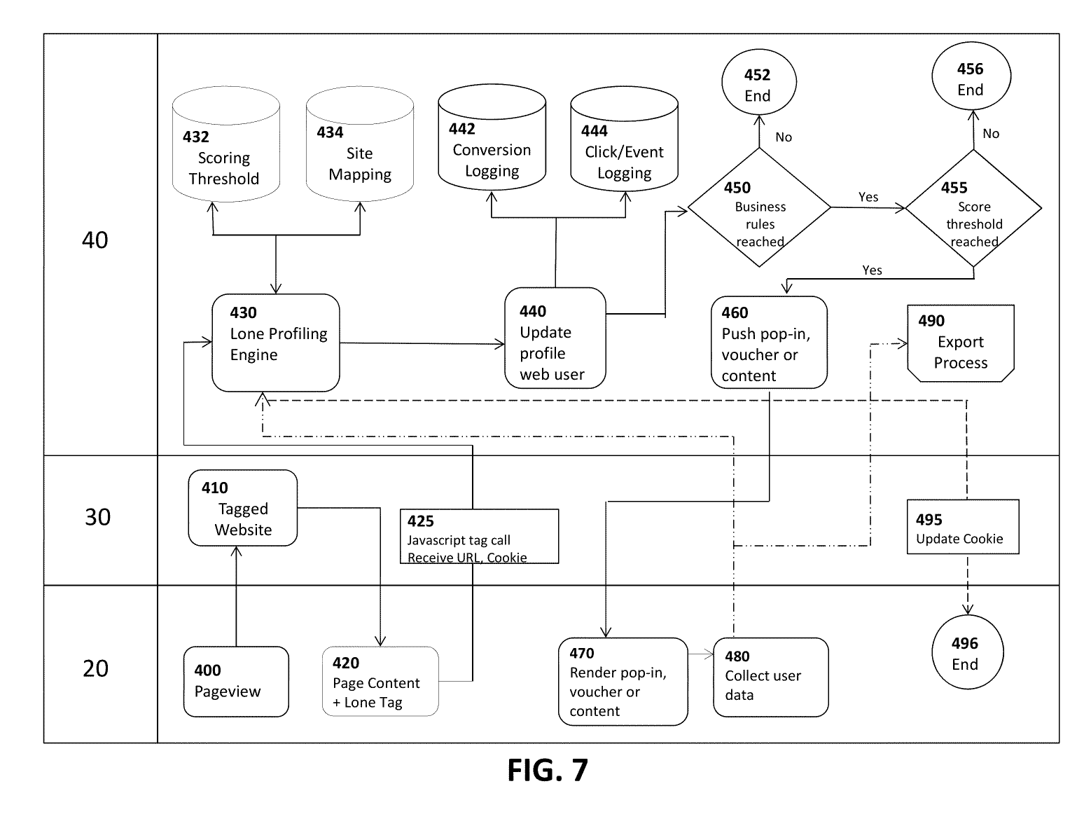

In an aspect, the scoring probability server 40 can be configured to capture actions of the user. In an aspect, the actions of the user can include raw events and raw conversions. The raw events (306), which can include, but are not limited to, the views, clicks, and other actions that are performed by a user (via the internet enabled devices 20) on a particular website (302) hosted by a vendor server 30. The scoring probability server 40 can be configured to collect the raw events (306) by a raw data import application 310, as shown in FIGS. 5 and 6.

The raw data import application 310 can be configured to monitor and/or import raw conversions, including, but not limited to, the submission of contact forms, subscription to programs and newsletters, the placement of (multiple) web orders, download of whitepapers and other items, and exposures and user responses to media (banners, search ads, emails . . . ) and conversion tools (as e.g. web forms, push content . . . ) from a variety of vendors (i.e., the vendor servers 30). In an aspect, the raw data import application 310 can capture the raw conversions as the conversions occur in real time. In an aspect, the raw data import application 310 can format the data 260 from the imported raw conversions for later utilization.

The scoring probability server 40 can then create comprehensive lists of all tracked events (e.g., view and clicks) captured (312) as well as lists of all of the tracked conversions (314) within the system 10. In an aspect, the raw data import application 310 can be configured to create the event lists (312) and conversion lists (314). These events (312) and conversions (314) can include all of those tracked by the scoring probability server 40, by the raw data import application 310 or other applications, as well as those from other sources that have been imported by the raw data import application 310. In an aspect, the raw data 260 can include, but is not limited to, sales conversion data from a customer relationship management (CRM) system.

In an aspect, the probability server 40 can be configured to utilize the event and conversions. In an aspect, a flexible attribution application 320 can utilize the lists of captured events 312 and conversions 314 to match specific events and conversions to one another in order to develop a sequence of events, also called sessions, that led up to a conversion. In an aspect, the flexible attribution application 320 can also capture and associate with the sequence of events/sessions the time for each event. These steps can be performed in real time. In another aspect, these sessions can be tracked over various time periods. For example, the probability server 40 can track for a single user all of the sessions that ultimately lead to a conversion. The probability server 40 can have parameters as to what defines the length of a session, discussed in detail below.

In an aspect, the segments generated, in combination with the sequence of the evens, can form couplets that show an interest within a category and the transition to another event/interest category. These transitions capture more information than single point estimates of category value by measuring two additional attributes: (1) the sustained within interest intensity of the user; and (2) the between interest variability and intensity of the user. The couplets are discussed in more detail below.

In an aspect, the flexible attribution application 320 can call upon attribution models to assist in the development of event sequences. In an aspect, the attribution models can be generated by modules of the flexible attribution application 320 (shown in FIG. 5), applications on the scoring probability server 40, or model generating applications found connected to or in communication with the scoring probability server 40. The generation of event sequences can be done in order to determine the correct marketing channel (e.g., digital areas) from which the event originated in order to distribute/attribute credit for actions resulting in a conversion (vendor server 30), as well as to determine ROI calculations.

In an aspect, the flexible attribution application 320 can be configured to generate attribution lists 322. Attribution lists 322 can be used for analyzing, evaluating and optimizing campaign performances. The attribution lists 322 can be merged with other datasets, including, but not limited to, campaign exposure (e.g., the information contained, used, and distributed with a particular advertisement campaign to which a given individual is exposed), advertising expenses, attributed revenue, and any other client-selected information to create a campaign report 324. In an aspect, a campaign application 323 can generate the campaign reports 324.

The campaign report 324 can be utilized to show the performance of a given campaign, as well as to feed optimization applications 325. The optimization applications can utilize various modules, algorithms, and methodologies. Such optimization modules, algorithms, and methodologies utilized by the optimization application 325 can include, but are not limited to, target expansion (look-a-like, clustering (i.e., target indirect audience with similar behavioral characteristics)), delivery optimization (score/frequency capping, i.e. the momentum and frequency of triggering interactions with a user), recommendation engines (i.e. product, service or content recommendations based on behavioral similarity with other users), portfolio optimization (bid/budget, e.g., budget allocation to media campaigns based on the engagement score generated, and/or install user specific bidding thresholds on ad exchanges based on score), search portfolio optimization tools, A/B Testing (display, onsite, search and landing page optimization), and domain clusters (e.g., similarity grouping of urls to be used for targeting). The campaign reports 324 and the output from the discussed optimization application 325 can be utilized by end-users of the system 10 (e.g., operators/system administrators of the vendor servers 30), and other systems to optimize media and marketing campaigns. The information from the campaign report 324, after processing by the optimization application 325, can be utilized to provide campaign model data 326, as well as provide specific campaign data sets 327. In an aspect, the optimization application 325 can be configured to generate campaign model 326 and specific campaign data sets 327.

In an aspect, the campaign model data 326 includes a set of optimization data normalized to pre-existing media campaigns to optimize delivery around the goals of a particular advertiser. As discussed above, the optimization application 325 can be configured to provide the optimization data in a normalized form. In an aspect, the campaign model data 326 can be utilized by an ad delivery/dynamic creative application 329 of the scoring probability vendor 40. The ad delivery application 329 can be configured to deliver creative tags (i.e. to increase the delivery of better performing copywriting and creatives) and links for display interaction impression (e.g., advertisements) won on a website of a publisher, or a client web site (i.e., hosted by a vendor server 30). In addition, the ad delivery application 329 can also be configured to deliver dynamic creative templates to map user interest to the advertiser's product inventory 338 (e.g., product list offered).

In an aspect, the specific campaign data set 327 can include specific configuration data for a given advertiser, including a list of hierarchical segments (a list of characteristics to monitor: e.g. a list of products, a list of possible actions on a website, a list of fields in a form that should be monitored, etc.), CRM configurations, lead generation forms and available campaign data for marketing efforts. The specific campaign data set 327 can be utilized by a campaign optimization application 330 for the delivery of marketing messages and lead generation, as shown in FIGS. 5 and 6. The campaign optimization application 330 can be utilized by outside sources, including, but not limited to, the vendor servers 30.

In an aspect, the scoring probability server 40 can be configured to utilize campaign setup data 328. The campaign setup data 328 can include hierarchical campaign structure data which maps to each vendor sever 30 utilizing the scoring probability server 40. The campaign setup data 328 can be utilized by a publisher synchronization application 331, as shown in FIGS. 5 and 6. The synchronization application 331 can be configured to leverage API libraries of a publisher server 332 (i.e., publishing server that lead to the event at the vendor server 30) to replicate, manipulate, and maintain campaign structures between publishers 332 (i.e., search engines, media and social applications) and the scoring probability server 40.

In an aspect, the scoring probability server 40 can also include pre-bid data integration 334 (the combination of data from different sources or the combination of different tags) for use with the publishers 332. In an aspect, the pre-bid data integrations 334 further comprises third party data integrations that qualify all real-time bidding functions within the scoring probability server 40. The pre-bid data integrations 334 can include data to qualify the inventory location (i.e., the set of data on a user-level) for contextual matches and creative selection (i.e., determining the most relevant creative (e.g., a displayed advertisement that is shown) for a given user). In an aspect, the scoring probability server 40 can utilize pre-bid data integrations 334 to process requests from a publisher to respond with an optimized bid. In an exemplary aspect, the pre-bid data integrations 334 can be utilized by a real-time bidding display application 336 that can process each raw request from a publisher 332 and respond with an optimized bid.

The real-time profiling and scoring application 208 (step 308), as discussed above, is configured to parse out segment interests, tie those interests to a particular user of an internet enabled device 20, and maintain a propensity to buy score per segment for each on a user profile basis. The scoring application 208 can utilize a user profile store 340. The user profile store 340 includes profiles of different users of the internet enabled devices 20. Each user profile can contain every segment/product interest and event observed by a user that has been captured by the system 10 via the scoring probability server 40. The user profile store 340 can include all information obtained by the scoring probability server 40, as well as the information from other third parties. In an aspect, a user profile import and export application 342 can integrate third party data of a user associated with an internet enabled device 20 with the information collected by the scoring probability server 40 into a user profile found in the user profile store 340. Such information can be done at a user cookie level (i.e., a user profile limited to a particular device (e.g., smartphone or PC)/browser combination). In an aspect, the user profile store 340 can be stored on the mass storage device 262 of the scoring probability server 40. In an aspect, the user profile import and export application 342 can also export the updated profiles stored on the user profile store 340 to vendor servers 30.

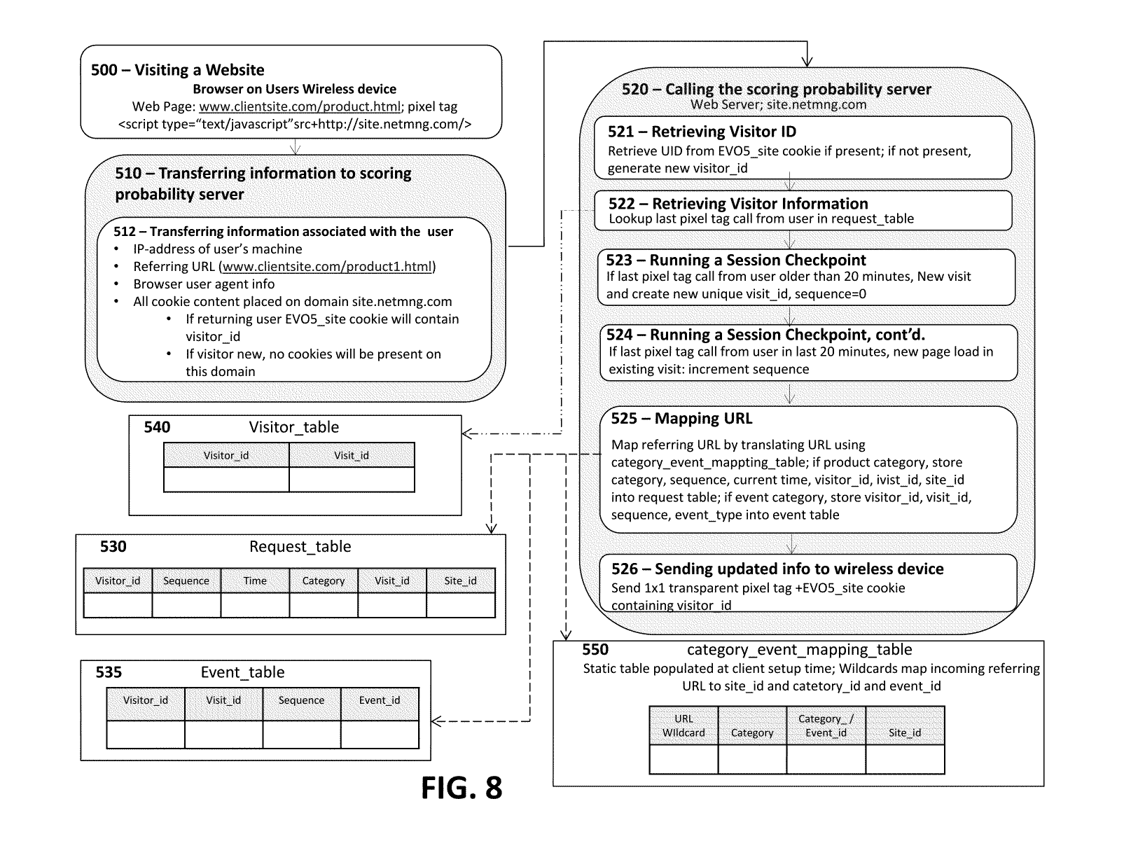

FIG. 7 illustrates a method performed by the scoring probability server 40 of the scoring probability system 10 according to an aspect. A user (via the internet enabled device 20) initiates the web browser application 108 to visit a webpage (step 400). The user will then come across a tagged website associated with a vendor server 30 that utilizes the scoring probability server 40 (step 410). When the tagged site is visited, the site through the vendor server 30 will deliver content of the page to the user together with the execution of the tag (step 420). The tagged website can include code (e.g., JavaScript) that, when executed (i.e., selected by the user), can send details of the page view, details above the visitor session, and cookies to the scoring probability server 40 (step 425). The user information can be utilized by the scoring probability server 40, and more specifically, the real-time profiling and scoring application 208 (step 430) to analyze the received data and generate a score in real time, discussed in more detail below.

Once a score has been generated, the scoring probability server 40 can compare the score to a scoring threshold (432). In an aspect, the profiling and scoring application 208 can compare the score to the scoring threshold, or call upon other applications to do the comparison. The scoring threshold is a predefined score. In an aspect, the scoring threshold is an eligibility check, which can be determined by pre-defined algorithms or set by account managers in order to control exposure. In another aspect, the scoring threshold is a goal that indicates whether people above that threshold will perform a given action (e.g., convert, buy, fill-in, click, etc.).

In an aspect, the scoring probability server 40 can also perform site mapping (step 434), wherein the site is segmented into logical areas. In an aspect, the scoring probability server 40 can call upon a mapping application to create the mapping. In another aspect, the profiling and scoring application 208 can perform the mapping. In an aspect, the mapping includes creating a logical area around a particular area on a webpage of the website. A logical area can be around a certain product or destination. In another aspect, a logical area can be around a certain user action (starting a funnel, using parts of a car configurator tool, looking for a dealer, looking at a gallery page). In an aspect, all physical url's are then rolled up to that map. The site mapping 434 can include segmenting the structure of a website (URL) based on logical business groups.

Once the mapping and scoring are done, the scoring probability server 40 can then provide a score and corresponding product/service. For example, if the scoring probability server 40 is being utilized by an automotive company, the scoring probability server 40 will provide the optimal moment/score to convert for a given car (e.g., Camaro).

Once the scoring has been determined and compared to the scoring threshold, as well as the site mapping, the user profile can be updated (step 440). In an aspect, the profiling and scoring application 208 can update the user profile stored in the user profile store 340 shown in FIGS. 5-6. The profile can be updated to include the scores as well as if a conversion has been performed. The data of an existing profile can be modified, added to, or enriched. In an aspect, external data can be integrated into the profile. In an exemplary aspect, the profiling and scoring application 208 can be configured to incorporate the external data in the profile. In an additional aspect, calculations can be performed based on the data, the results of which can then be integrated into client defined business rules. Such calculations can be performed by the profiling and scoring application 208, or can be performed by other applications and modules at the request of the profiling and scoring application 208.

In an aspect, if an existing profile cannot be found by the profiling and scoring application 208 that corresponds with the user of the internet enabled device 20 being used and currently monitored, a new profile can be created. In addition, conversion logging (step 442) and click/event logging (444) can be performed, and associated with the user profile. In an aspect, the flexible attribution application 320 can perform the conversion logging and click/event logging as the attribution application 320 is generating the corresponding event lists 312 and conversions lists 314 discussed above. In an aspect, the conversion logging (442) includes logging in a database (e.g., in the form of conversion lists 314) the conversion, if one has occurred, on a website. In an aspect, conversion can include, but are not limited to, filling a form, clicking on content, and the like. In general, a conversion can be described as taking a certain action on a website. The click/event logging (step 444) include logging in a database the clicks (e.g., in the form of event lists 312) on a web page of a site. The data includes data about the page and the visitor to the page.

Once the information has been updated (profile and the like), the scoring probability server 40 can then determine whether or not a business rule has been performed (step 450). In an aspect, a business rule is a predefined action or behavior. In an aspect, the business rule will look to the conversion log 442 to find whether or not a user associated with the profile performed the action or behavior. If the behavior was not performed, the scoring probability server 40 ends the process (step 452). If the behavior has been performed, the scoring probability server 40 will then determine whether or not the score of the user is larger than a predefined score (i.e., the threshold) (step 455). If the score of the user does not meet the threshold requirement, the scoring probability server 40 stops the process (step 456). However, if the score of the user does meet the threshold, the scoring probability server 40 creates content (e.g., creatives) (step 460). In an aspect, the scoring probability server 40 can call upon the ad delivery application 329 to deliver such content when the score provided by the profiling and scoring application 208 meets or exceeds the threshold. The content can be based upon a set of content elements. In an aspect, the content can take the form of a pop-in, voucher, or other form of content, which provide added value to the client. Once the content has been generated, the scoring probability vendor 40 supplies content to the internet enabled device 20 via the vendor server 30 to be displayed to the user (step 470). Upon the user interacting with the content the internet enabled device 20, the scoring probability server 40 can then collect more user data (step 480). In an aspect, the scoring probability server 40 can record the behavior of the user based on the interaction, if the interaction was finalized (e.g., possible conversion) as well as the information submitted by the user. The data about the customer/user can then be exported and stored in the user profile (step 490), stored in the user profile store 340. In an aspect, the data can be used to update the user information (i.e., cookie) on the internet enabled device of the user (step 495). Once completed, the scoring probability server 40 can then stop the process (step 496).

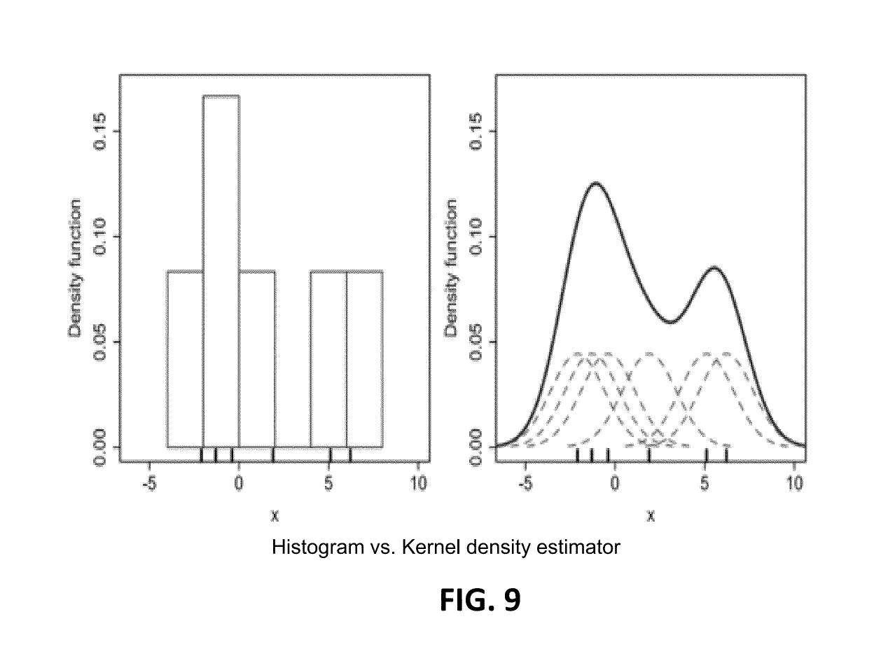

FIG. 8 illustrates another process performed by the profiling and scoring probability application 208 according to an aspect. The method is triggered when a user utilizing an internet enabled device 20 visits a website of a vendor server 30 that utilizes the scoring probability server 40, as shown at 500. The website contains a universal tag 304 (see FIG. 6). The tag 304 will call a script, which is defined by the tag. In an aspect, the script is configured to first identify a user and collect information related to the user (e.g., the user profile and cookie). When the script is activated, information is transferred to the scoring probability server 40 (step 510). The information that is transferred includes information associated with the user (e.g., profile and cookie) and the website. In an exemplary aspect, the information can include the referral URL, the IP-address of the user, the browser agent information, and the current URL, which can be sent to the scoring probability server 40 (step 512).

Upon receipt of the information/execution of the script, the scoring probability server 40 can then call upon the scoring probability application 208 (step 520). The scoring probability application 208 can check to see if there is a corresponding cookie and profile, found in the profile store 340, containing the visitor id associated with user provided by the scoring probability server 40. The profiling and scoring probability application 208 can then retrieve the visitor id (step 521). If a corresponding visitor id cannot be located, the profiling and scoring probability application 208 will generate a new visitor id, which will eventually be stored in a new generated user profile and cookie set up for the visitor. If the profiling and scoring application 208 finds a corresponding visitor id, the profiling and scoring application 208 will retrieve the visitor information associated with the visitor id (step 522). Here, the profiling and scoring application 208 will look up the visitor id in the user database (340) and find the visitor information, if any. In an aspect, the visitor information can include session information, which includes the time of the last page request/event (i.e., a click) and a visit identifier (i.e., a visit id) of that last request/event. In addition, the session information can include the score at the beginning of the session and the score at the end of the session. The visitor information can also include past segment interests and event sequences. The event sequences can include a sequence indicator that keeps track of the number of requests/events by a user during a session, discussed in more detail below. In an aspect, the look-up can look to a visitor table or profile store 340 (540).

Once profiling and scoring application 208 finds the last request/event associated with the user, the profiling and scoring application 208 will run a session checkpoint (step 523). The checkpoint looks to see if the last request/event that was processed occurred after a predetermined time period. In an exemplary aspect, the checkpoint looks to see if the last request was processed longer than 20 minutes previous. If so, a new session is created, creating a new visit id, with the sequence counter being reset to one. Otherwise, the old visit id is retained. In either case, a new page load is added. In addition, the last captured score associated with the individual from the last session can be adjusted based upon the lapse of time between the current request and last request. The page load can be added to the valid visit id (not more than one visit should be active at the same time), adding an increment to the sequence counter (step 524). In either aspect, the new request/event is added, which corresponds to the visiting of the URL.

Once the request/event has been added, the profiling and scoring application 208 can then map the URL (step 525). In an aspect, the mapping of the URL encompasses translating the URL to a category (e.g., product), a user action (e.g. visiting a gallery page, starting to fill out a form) or event (e.g., conversion). If the URL falls within a product category/interest segments (e.g., hierarchical segments, CRM configurations, user actions, lead generation forms and available campaign data), the profiling and scoring application 208 will store the category, the sequence leading to the category, the current time, the visitor/user id, visit id, and site id into a request table (530). In an exemplary aspect, one URL could be mapped to multiple categories, e.g. a product interest and a user action. If the mapping shows that the URL is an event category, the profiling and scoring application 208 will store the visitor/user id, visit id, sequence, and event type into an event table (535 or 550). In an aspect, an event category can be defined as business rules, or special actions that take place. These events are used to evaluate business rules stored and executed on the scoring probability server 40 as well as to track and evaluate the nature of the response (e.g., steps 450-470 discussed above). The events can include certain actions, such as, but not limited to, triggered, sent, shown, saved, and closed. These events then can be coupled to the creatives, tracking the progress of the interaction (e.g., did the user fill in the pop-in, etc.).

After the entries are made into the respective tables after the mapping, the profiling and scoring application 208 can then send a response and update the information in the cookie, or set a new cookie (step 526) to the internet enabled device 20 utilized by the user. In an aspect, the profiling and scoring application 208 will set the cookie and send a response script (e.g., send an interaction if applicable) while saving the request information (visitor/user id, visit id, category, site id, time), and update the visitor information, and any other tables. In an aspect, the process discussed above does not have to be strictly separated; a creative can be sent, the user can interact with the creative while logging the actions of the user (e.g., send a response to the vendor server 30 when the user sees the interaction/creative). Once mapped, the profiling and scoring application 208 can then derive the score for conversion.

As discussed above, the profiling and scoring application 208 is configured to generate or predict a probability of a particular user converting in a single score. In an aspect, the score can be generated in real time. This score is a composite of the browsing history of the user coupled to a set of interest categories. The profiling and scoring application 208 can utilize various components to determine the score. For example, the components can include, but are not limited to, the URL (category), time between requests/events, conversion information (static), geographic location, meta-information, internal information (keyword history, display history), third party data, actions on the URL (if logged), operation system (OS), browser, time of day, day of week, and the like. In an aspect, the couplets (within and between interest categories) of the sequence of browsing history can be utilized. These transitions capture more information than single point estimates of category value by measuring two additional attributes: (1) the sustained within interest intensity of the user; and (2) the between interest variability and intensity of the user.

In an aspect, the profiling and scoring application 208 can utilize a sequence of a user's browsing history to see the within and between interest categories. In such an aspect, it is assumed that the sequence of a user's browsing history represents individual exposures to interest categories traversed by the user. A sequence can represent a variable number of exposures. In addition, a sequence of a user's browsing history also represents the time spent within each exposure to the interest category. In addition, a sequence of a user's browsing history as captured is correlated with a ‘level of interest’ for a user. The level of interest can be primarily determined by the converting probability.

The scoring probability server 40, through the profiling and scoring application 208, can utilize a number of different approaches to determine a score for a particular sequence. For example, consider a sequence: ABDCBDBCA, with the set {A,B,C,D} corresponding to interest/product categories. In this example, the sequence is a collection of steps in a user's browsing session, and categories are URL's as grouped into bins. The bin grouping can be based upon a mapping conform from a client. The profiling and scoring application 208 looks at the transitions or couplets (i.e., the transition from one category at sequence x to another one at sequence x+1 as shown in Table 1.1 below), thereby cutting the sequence in several little pieces. Such transitions don't have to be different; one can revisit the same page or stay in the same sequence.

TABLE 1.1

| 1 | 2 | 3 | 4 | 5 | 6 | 7 | 8 | 9 | 10+ | Sequence |
|---|---|---|---|---|---|---|---|---|---|---|
| A | B | D | C | B | D | B | C | A | . . . | — |
| A | B | — | — | — | — | — | — | — | . . . | 1 |
| — | B | D | — | — | — | — | — | — | . . . | 2 |
| — | — | D | C | — | — | — | — | — | . . . | 3 |
| — | — | — | C | B | — | — | — | — | . . . | 4 |
| — | — | — | — | B | D | — | — | — | . . . | 5 |
| — | — | — | — | — | D | B | — | — | . . . | 6 |
| — | — | — | — | — | — | B | C | — | . . . | 7 |
| — | — | — | — | — | — | — | C | A | . . . | 7 |

From this, the probability that an observed couplet is part of a converting sequence is computed. A converting sequence is a sequence that includes someone converting. In an aspect, the converting sequence is only up to the point of the first conversion since later information is not relevant anymore. In an exemplary aspect, to correct for the bias that could be generated by simply counting the sequences (≈standard mean), the profiling and scoring application 208 utilizes a Bayesian mean. Just counting the observations would give equal weights to each bin, regardless if there is a lot of information in them or not. One accidental success in one bin could give a completely false image of the reality and hence bias the estimates. Because one can consider multiple levels: overall mean (probability that a transition converts), mean over one observation, and/or mean over a pair of observation:couplet, the profiling and scoring application 208 applies the calculation recursively (i.e., each level is calculated using the information of one level below it). Bayesian modeling postulates that information from the lower levels can be used as prior (skeptic) information for the next levels; not disrupting the overall mean, but reducing the impact of random occurrences for transitions that rarely occur.

Such a calculation utilizing a Bayesian mean results in an adjusted estimated conversion probability for a couplet. In an aspect, the profiling and scoring application 208 can be configured to assume that a couplet has a different affect when it shows up at a different place of the sequence. Such an assumption increases the specificity of detection for a transition. While other aspects of the profiling and scoring application 208 can make other assumptions, this assumption is the more conservative assumption to take. The performance of each couplet is estimated for each section, as shown in Table 1.2 below.

TABLE 1.2

| Section | Start | End | prior Start | Prior End |
|---|---|---|---|---|
| 1 | 0 | 1 | — | — |
| 2 | 1 | 2 | 0 | 1 |
| 3 | 2 | 3 | 1 | 2 |
| 4 | 3 | 4 | 2 | 3 |
| 5 | 4 | 5 | 3 | 4 |
| 6 | 5 | 6 | 4 | 5 |
| 7 | 6 | 8 | 5 | 7 |
| 8 | 8 | 10 | 7 | 9 |
| 9 | 10 | 15 | 9 | 14 |
| 10 | 15 | 22 | 14 | 21 |
| 11 | 22 | — | 21 | — |

In an aspect, the profiling and scoring application 208 can divide the sequence of browsing by the user into sections, as shown above. In the current example, the browsing path is divided in a number of sections (11): {1, 2, . . . 11}, based on the observed counts before a certain point in the session (e.g. 1^{st} click, including this one, End in the table) and after a certain point (e.g. 0^{th} click, not including this one, Start). The size of those groups is almost the same in a group. The information from table 1.2 can then be used with a set of hierarchical equations (1.1, 1.2, 1.3, 1.4), shown below, to determine the score.

$$\begin{matrix}p ( - \vert k ) = \frac{{\sum }_{i = 1 \vert k}^{i = n \vert k} {\sum }_{j = 1 \vert k}^{{i}_{1} \vert k} {δ}_{ij}}{{\sum }_{i = 1 \vert k}^{n \vert k} {\sum }_{j = 1 \vert k}^{1 ( i ) \vert k} 1} & ( 1.1 ) \\ E ( A \vert μ , k ) = \frac{μ \vert k + x + {\sum }_{i = 1 \vert k}^{n \vert k} {\sum }_{j = 1 \vert k}^{{i}_{1} \vert k} {δ}_{ij}}{( {\sum }_{i = 1 \vert k}^{n \vert k} {\sum }_{j = 1 \vert k}^{{i}_{1} \vert k} 1 ) + x} & ( 1.2 ) \\ E ( AB \vert E ( A \vert μ , k ) ) = \frac{E ( A , k \vert μ ) * x + {\sum }_{i = 1 \vert k}^{n \vert k} {\sum }_{j = 1 \vert k}^{{i}_{1} \vert k} {δ}_{ij}}{( {\sum }_{i = 1 \vert k}^{n \vert k} {\sum }_{j = 1 \vert k}^{{i}_{1} \vert k} 1 ) + x} & ( 1.3 )\end{matrix}$$

Equation 1.1 determines the probability that a symbol j (representing the proportion of a sequence that falls in a session bin (other way of putting the text above before end (including this click) and after start (not including that one) (e.g., the 15th click belongs to session 9 from a user i))) leads to a conversion at a certain time-point k (without taking into account the specific nature of this symbol j), with δᵢⱼ being a Kronecker-delta indicator of conversion. In an aspect, equation 1.1 is just a mean over all sequences per time bin. The next equation 1.2 is then an indication of the probability that an observed symbol in a given time-bin is a converting symbol. The two differences between this and the last approach is that here the overall mean is used with a prior weight of x(50). x(50) is a count on category level, over the different session bins, using the overall counts (not on category level) over the session bins as a prior. One can think of this as adding x sequences with a value equal to the mean value to the observed outcomes. Equation 1.3 uses then the probability of observing a particular symbol at a certain point as a prior of the probability that the sequence will convert.

The probabilities obtained from equations 1.1-1.3 are a measure of the likelihood of converting. However, the raw probabilities are difficult to translate into scores. The raw probabilities are highly unstable which would require complicated artificial mechanisms to maintain within stable ranges. In addition, the raw probabilities do not pick up the absolute changes in conversion probability that would signify beneficial or detrimental transitions that may be meaningful for a score. To correct for this, the profiling and scoring application 208 can calculate marginal probabilities. This marginal change is the difference between the probability calculated via equation 1.4 and the appropriate prior sequence window (table 1.3). Probabilities as calculated in the equation below, with the changes in marginal probability results being shown in table 1.3.

$$Δ P ( AB ) = P ( AB ) - \frac{( {\sum }_{i = 1}^{N} A \vert {k}_{1} + x ) P ( A \vert {k}_{1} ) + ( {\sum }_{i = 1}^{N} A \vert {k}_{2} + x ) P ( A \vert {k}_{2} )}{2 * x + {\sum }_{i = 1}^{N} A \vert {k}_{2} + {\sum }_{i = 1}^{N} A \vert {k}_{1}} \qquad ( 1.4 )$$

TABLE 1.3

| Cat | Cat2 | [1] | [2] | [3] | [4] | [5] | [6] |
|---|---|---|---|---|---|---|---|
| −1 | 300000015 | 0.013 | 0.026 | 0.031 | 0.020 | 0.021 | 0.020 |
| −1 | 300000012 | 0.039 | 0.023 | 0.025 | 0.043 | 0.034 | 0.003 |
| −1 | 300000006 | 0.023 | 0.019 | 0.025 | 0.033 | 0.029 | 0.042 |
| −1 | 300000003 | 0.016 | 0.007 | 0.024 | 0.026 | 0.018 | 0.004 |
| 300000015 | −1 | 0.041 | 0.017 | 0.022 | 0.010 | 0.009 | 0.040 |
| 300000011 | 300000011 | 0.035 | 0.004 | 0.021 | 0.039 | 0.028 | 0.029 |
| 300001000 | −1 | 0.002 | 0.012 | 0.020 | −0.017 | 0.005 | −0.003 |

In an aspect, the categories (Cat, Cat 2) can be identifiers, and can represent user actions, products advertised, and the like. The numbers associated with a given time bin [1], [2] signify an estimate of the marginal effect on the estimated probability to convert after going from cat to cat2 in time bin [1],[2]. Conversion probability is calculated on historical behavior of converters and non-converters with similar characteristics, conformed to the specified criteria. The main problem with prior sequence windows is that those windows can span multiple classes, although this is not always the case. For example, as shown in sequence 1, 2, (as shown in Table 1.2): on the first transition (so, the first two clicks), for a new visitor, there is no probability estimate; for the 8^{th} bin, there is some proportion of the clicks coming from the 7^{th} bin and some proportion coming from the 8^{th} bin. This is even worse when the priors for pairs are considered (e.g., some might have observations that belong to three classes). So, considering for example the transitions AB; we know that the visitor came from A; but to correctly calculate the estimate we should consider the probability that he came from BA ; CA ; . . . ; ZA.

The final variable the profiling and scoring application 208 considers is the amount of time spent on a particular exposure. It is important to remember that due to onsite measurement systems, this is the time spent on the previous exposure of the couplet. In an aspect, the profiling and scoring application 208 uses time as a weighting mechanism that increases or decreases the impact of the marginal probabilities. In an exemplary aspect, to create the weighing factor for time, the profiling and scoring application uses a restricted ratio of 2 Kernel Density Estimators (5) on the range [−50, 1000], and calculated in the formula below:

KDE_{Conv}/KDE_{NonConv}

However, in other aspects, other ways can be utilized to change the impact of the marginal probabilities. Referring back to the range discussed above, the ratio is restricted in this way, limiting it to the range [0.5, 2]. Expanding upon this, one can see that this ratio is also likely to introduce an unbalance in the distribution of the scores: the lower scoring transitions, visited more often by non-converting users are more likely to receive a down-lift which will be smaller on average than the corresponding uplift.

In order to have a score that is proportional to the likelihood of static conversion, the profiling and scoring application 208 utilizes a linear combination of the times and the transitions and restricts it to a probability (equation 2.1). The X's represent the marginal transition probability (i.e., Eq. 1.4) while the Tij represents the ratio's between the different time-densities (i.e., KDE_{Conv}/KDE_{NonConv}). The Pij are then indications of converting probabilities.

$${P}_{ij} = max ( 0 , min ( 1 , {\sum }_{i = 1}^{n} {X}_{ij} {T}_{ij} ) ) \text{∀} j : users , i : transitions \qquad ( 2.1 )$$

In an aspect, it is desired to have a scoring system 10 that minimizes the variation between converting users (supposedly higher-scoring users) and maximizes the difference with non-converting users (mainly lower-scoring users). In such an aspect, the scoring system 10, via the profiling and scoring application 208, utilizes a log-transformation (assuming that the probabilities for converters are higher than for non-converters). To have a valid log-transformation, the profiling and scoring application 208 adds 1 to the probabilities t(Pij)=log(Pij+1). The quantiles of the resulting values follow a logistic function, allowing them to be mapped to a line via log-transformation.

In an aspect, the profiling and scoring application 208 can map the separated coefficients to a score using a (quantile) regression (q=0.50). A link between the score and a probability must be formed. In an aspect, the profiling and scoring application 208 finds a map that minimizes the distance between the factual score (converted or not) and the predicted score (represented by the map on the probability). In an aspect, the profiling and scoring application 208 takes a regression to do this task. In an exemplary aspect, the profiling and scoring application 208 utilizes a quantile regression with q=50 to make sure that the median is as close to the expected value as possible. This kind of regression ensures that the distance (i.e., absolute deviation) between the observations and the expected conditional median is as small as possible. In an exemplary aspect, in order to minimize the variation, the profiling and scoring application 208 applies a cutoff (actively capping the maximum scores, and therefore limiting the possibility of a maximum score). The final equation is shown below (2.2).

Sᵢⱼ=min(t(Pᵢⱼ), cutoff)*β (2.2)

In an aspect, the profiling and scoring application 208 can add another variable that corresponds to a basal score at that time. The basal score would represent the score that one gets without performing any action (as a result in the same regression), allowing the profiling and scoring application 208 to give visitors prior scores that correspond to the likelihood of converting at a certain point (as chosen in the examples), or to give them a strictly increasing base-score that would correspond to the ‘interest’ that globally must increase (eq. 2.3).

Sᵢⱼ=min(t(Pᵢⱼ), cutoff)*β+Aᵢ (2.3)

In order to evaluate the score from these equations above, the profiling and scoring application 208 needs to combine information from two sources: one lookup table containing the probabilities (optimized per client), and one lookup table containing the ratios of time densities (i.e., the density of time spent on a URL for a convertor versus a non-convertor for a given amount of time). Such information is used to generate raw probabilities (i.e., Pᵢⱼ). The data is plugged into equation 2.3. The formation of the first and second tables can be determined by system administrators, which can consider a number of factors. In an exemplary aspect, the first and second tables will be determined by the amount of time (1000) and the number (N) of categories. Referring to table 1.2, the number of categories is limited to 11, leading to the lookup table containing the probabilities having exactly N² rows and 11 columns (session categories). Since time is limited, the second lookup table (ratios of time) will have 1000 rows with 11 columns. At each point, the score can be calculated by the following formula:

$$Score = ( {X}_{i} ) + β min ( cutoff , log ( ( {\sum }_{i = 1}^{n} {S}_{ij} {T}_{ij} ) + 1 ) )$$

Xᵢ is the probability estimator at point i, Sᵢⱼ is the marginal change in probability at point i for couplet j, Tᵢⱼ is the ratio of times spent on the pages, both of which can be derived from the mentioned tables. The cutoff value is the maximum score that can be obtained.

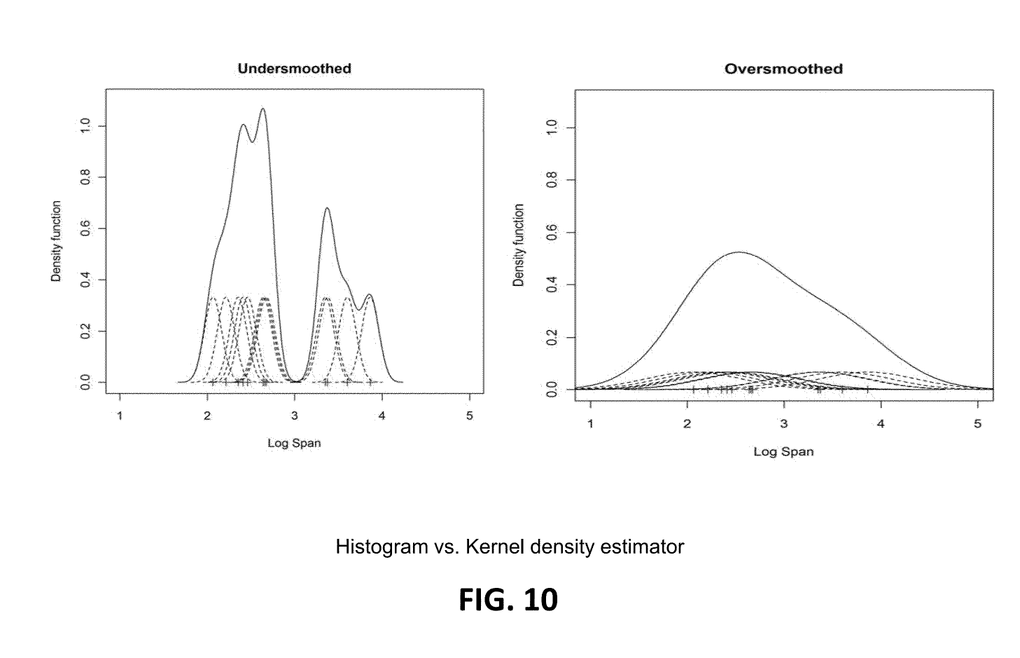

In order to calibrate the score, the profiling and scoring application 208 calculates the probability of shifting from one category to another category. In an aspect, a Kernel density estimator is utilized by the profiling and scoring application 208 to calculate the ratios of the time densities. The kernel density estimator is a non-parametric estimator for the probability distribution that grew out of the average shifted histogram estimator for the density. This estimator estimates the density function at a certain point by plotting multiple histograms, adding them and normalizing them, as shown in FIG. 9. For every datapoint, in the vicinity of a datapoint, a kernel function (Gaussian, Epanechnikoff, . . . ) is fitted over that point with a certain bandwidth (e.g., using the plugin bandwidth as a parameter for the kernel density estimator). In an aspect, the profiling and scoring application 208 is configured to determine the bandwidth (or the width of the kernel function), which greatly determines the actual performance of the methods used, as shown in FIG. 10. Under-smoothing is the case of choosing the bandwidth too low, while over-smoothing is the case of choosing the bandwidth too high, yielding a figure that is either too smooth (no details are visible), or not smooth enough (the noise is modeled instead of the signal).

To approximate the Kernel estimator, the profiling and scoring application utilizes a local weight of a shifted histogram divided by the total weight of the observations, yielding a probability distribution. In an aspect, the shift can fit the data, and approximate the actual density, because the observed values are discrete in nature.

The calibration of the regression requires the use of two unknowns: the cutoff and regression factor. Neither of the unknowns is independent, and therefore cannot be optimized separately. In an aspect, the optimal parameters can be found by the profiling and scoring application 208 by applying a regression on each point of a line-search for the cutoff. The cutoff can be a ceiling applied to the regression to limit the score-ranges. In an aspect, huge values are not needed; simply knowing that someone is much more likely than another user can be enough in such aspects. The profiling and scoring application 208 can find the optimal coefficients by looking for the minimum sum of Euclidian distances between the regression median and the predicted values for the convertors added to the sum of the Euclidian distances between 0 and the predicted value for the non-convertors, multiplied by a constant, shown in equations 3.1 and 3.2 below. The results of these equations are then added, and the minimum of the sum of these equations is calculated by a line search.

Opt=(min(100−t(Pⱼₙ,cutoff)*β)²)*C+∀0<cutoff<1; Conv:j; n: sequencelength (3.1)

min(t(Pⱼₙ,cutoff)*β)² ∀0<cutoff<1; NonConv; n: sequencelength (3.2)

In an aspect, the inclusion of returning-user-specific modifications can be done by having the profiling and scoring application 208 use a specific slope (scores of returning users behave differently) and/or including a different intercept (conform the basal score). The intercept is then a function of the prior score (basal score (score assigned to every user indicating the basal level of conversion; could be 0) (working with score that signifies no prior interest)), but also of the score in the last session, by a combination of those or by modeling them differently. To estimate those models, a slight modification of equation 3.1 can be used; and solutions can be found instead of using a line-search, using a grid-search or different optimization technique.

In an aspect, the scoring system 10 can utilize a score to determine product interest intensity. The determination does not necessarily utilize a linear model because product interest cannot simply be assumed to be equal or even directly proportional to probability of converting, nor does the total of product interest necessarily needs to equal 1. In an aspect, the product interest can be mapped using a multinomial vector. For example: user 1 is interested in product A and product B, but instead of giving him identical score like 50% A, 50% B, giving him scores like (x % A, y % B), depending on the relative intensity of his interests (4 clicks on A and 6 clicks on B means a 40% interest in A and a 60% in B). However, using the derived equations, one could also create a model per product and utilize that standardized score (max is 100) to get the product intensity. Further, other factors like memory and aging, may eventually become important, and used to link this information across multiple sessions.

In an aspect, the score helps the system 10 to position the user in a buying decision cycle, and in his customer lifecycle, and pinpoint the content, the method and the moment of interacting with the user. With different scores making up different phases in the lifetime cycle, the system 10 can then use the vector of scores to estimate the position of the user in this buyer decision cycle; the system 10 can then estimate that this user is much more likely to be interested in after-sales support than he is in any given product and use that information to help establishing the nature and timing of the interaction.

In an aspect, the scoring system 10, and more specifically the scoring probability server 40, can be used to monitor the interaction with a pop-in used by a vendor server 30 on a user's device 20. In an aspect, the pop-in can be studied by making longitudinal cuts in the population (assuming the pop-in is shown at a certain lead target), and comparing that with the scores generated by the profiling and scoring application 208 and using the results on those scores to get an idea of the marginal effect of the pop-in on the resulting probabilities.

In an aspect, the equations above, utilized by the profiling and scoring application 208 were tested on four different datasets: Hokende, Telford, Betfred and Tele2. The performance of the profiling and scoring application 208 was mainly evaluated using three measures: (1) specificity (how good is the profiling and scoring application 208 at detecting the ones that are going to convert and are the majority of the scores found around the target scores); (2) selectivity (is the profiling and scoring application 208 able to separate the converting sequences from the non-converting sequences preferably at each step in the process, and how many non-converting sequences will we catch at the conversion region); and (3) range (what is the range in which the converting sequences end up at the conversion point (shown in Table 4)).

Beyond this, a few other tests were also executed: a breakdown test (can the profiling and scoring application 208 handle a small input size without completely breaking down); and a generalization test (can the profiling and scoring application 208 handle returning visitors? Do they behave in a similar manner? Can they be identified in a straightforward manner?).

TABLE 4.1
Some summary statistics for the Telfort

| Min. | 1st Qu. | Median | Mean | 3rd Qu. | Max. |
|---|---|---|---|---|---|
| 46.49 | 89.24 | 99.10 | 95.95 | 105.90 | 109.70 |

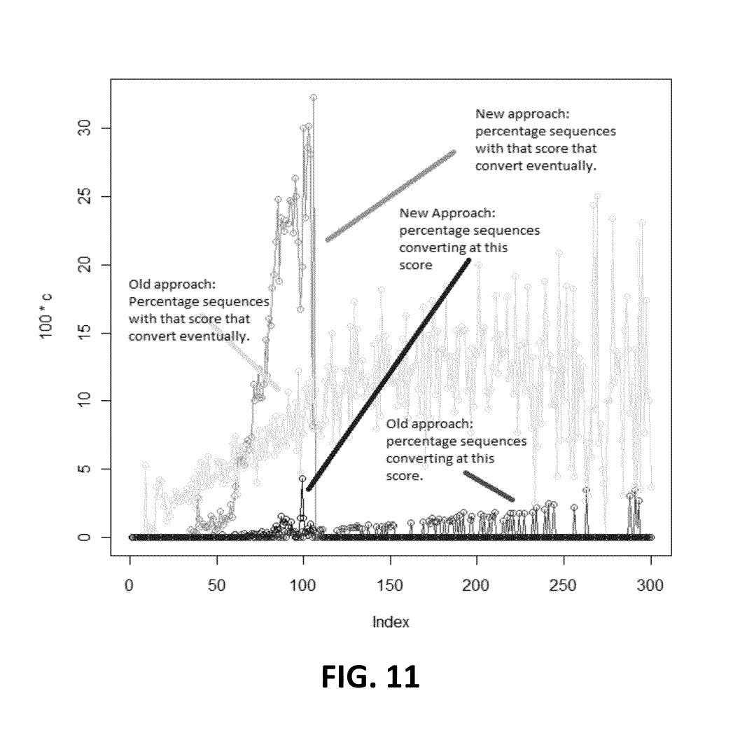

The results for the range were straightforward: >75% is found between [89.3;109.7], with a median of 99.10. (These values are obtained on a cross-validation sample). For the other measures, the results are compared to older methods, to get an idea of the relative performance. Both measures are captured in two types of plots to get an indication of the longitudinal and cross-sectional performance on the Telfort dataset, shown in FIG. 11. The data shows the performances of older scoring methods and the method employed by the profiling and scoring application 208 discussed above. More specifically, the figure shows the proportions of the population scoring eventually and at a given score.

From FIG. 11, one can observe that the scores from the profiling and scoring application 208 for showing conversions at a certain score are centered around 100, with a sharp increase in the selectivity as the score gets closer to 100. This would mean that the system 10 is able to identify the converting sequences fairly quick, and lets them convert around the appropriate score. This is clearly contrasting with older scoring approaches, where the largest proportion of convertors end up at the end of the scale. Another conclusion one can draw (or from the equations) is that the score is bounded (above).

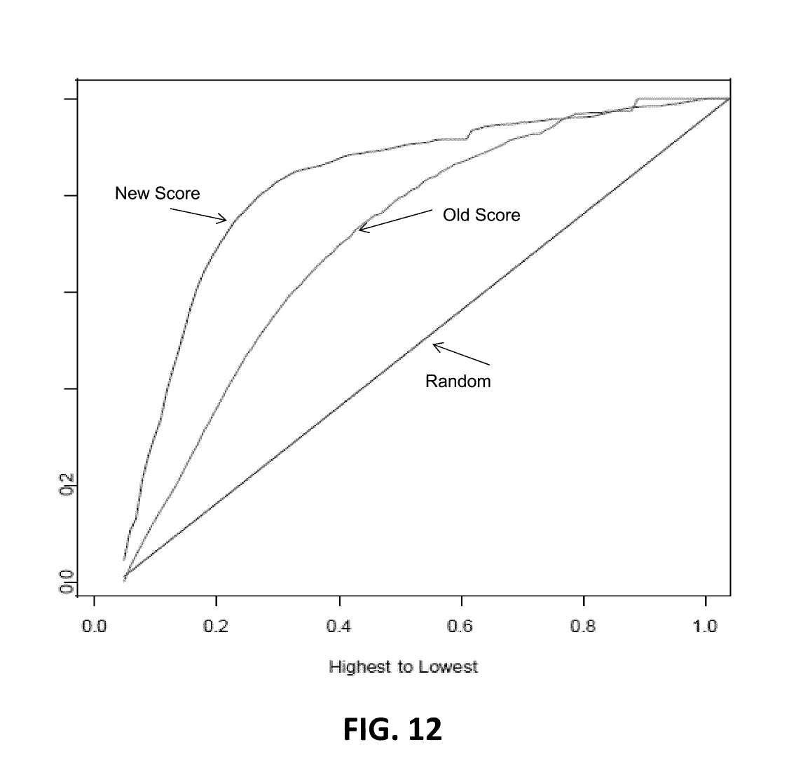

Another graph that is of interest is the Gains chart, as shown in FIG. 12, which depicts the pickup speed for the current system 10 compared to older systems and methods: The focus is on the sensitivity vs. specificity trade-off, ignoring the standardization of the core. This chart illustrates that the system 10 performs better than other older methods.

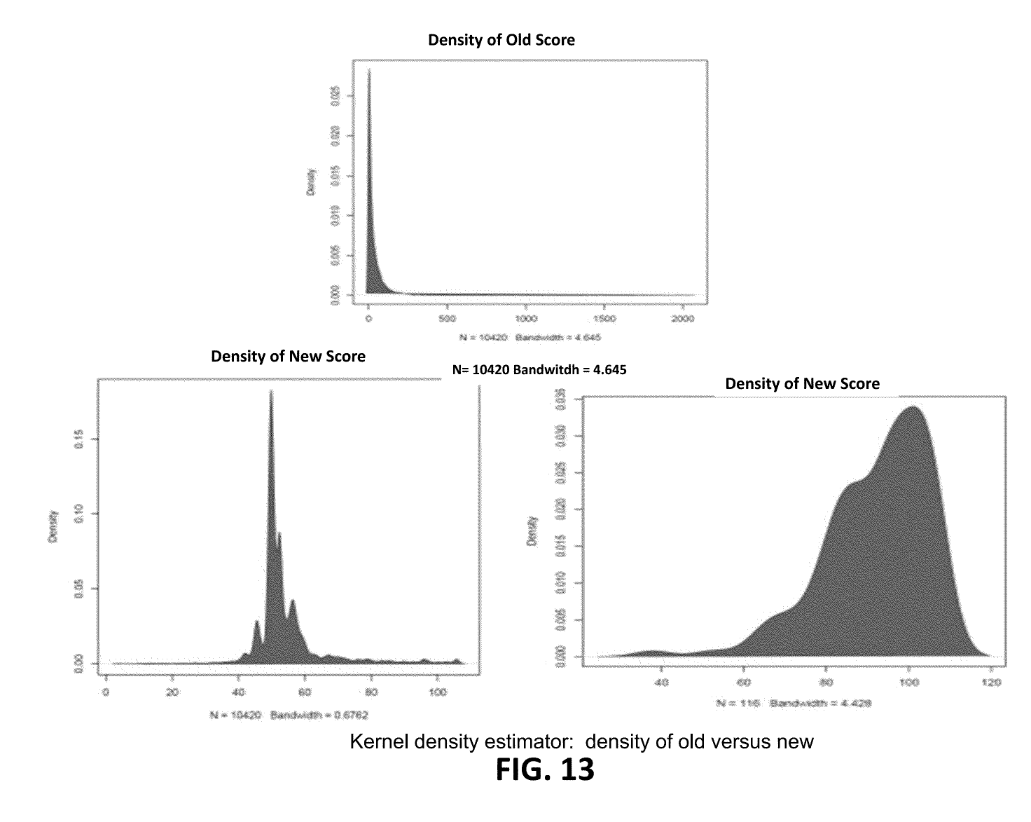

The last relevant plots are the score density plots (shown in FIG. 13), which displays the density (histogram) of the score between the system 10 compared to older methodologies. One can see from the left graph that there exist significant differences between the two approaches: the old density strongly resembling the exponential density function while the new one contains much more detail. For example, we can identify clusters with a different behavior. We can also see different groups move away from the mean. The right screens show the corresponding converting score densities and we can observe that they are much higher for the system 10.

In an aspect, the flexible attribution application 320 can be utilized to assign values/portions of the generated score to each marketing exposure/channel in a converting path (i.e., all the activity that leads to a conversion). These portions of the generated score are based upon the proportion each exposure/channel played in the role of ultimately leading to a conversion.

The flexible attribution application 320 utilizes much of the same information used to generate the score 309 by the scoring application 206. In an aspect, the flexible attribution application 320 will utilize information that can be obtained from the user profiles that are associated with a conversion. Such information can include the cookies and profile, as well as the session information and conversion associated with the user. The session information, as discussed above, can include the sequence of exposures, the timing for each sequence, the events for each sequence, and other relevant information, such as the source of the exposure (e.g., the URL). In addition, the score associated with the conversion is included as well.

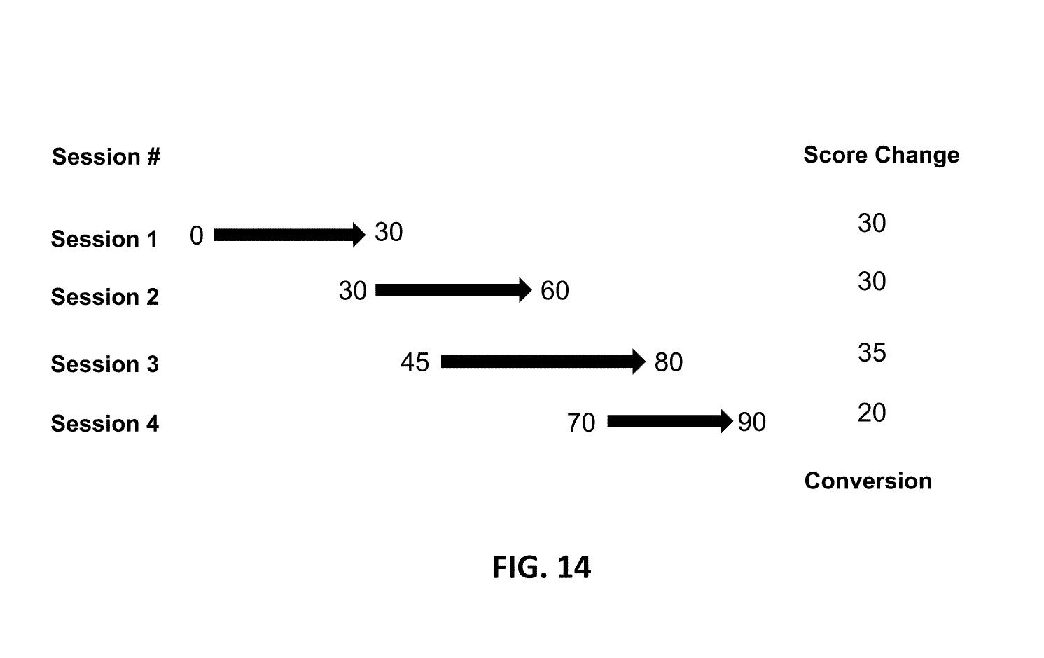

As discussed above, each session of a user has a unique score based on the behavior of the user and the engagement the session generated onsite. In an aspect, the score for each session can be defined by subtracting the score at the beginning of the session from the score at the end of the session. This can be done for each session by a user until a conversion occurs. FIG. 14 illustrates a user that performed four sessions until the conversion occurred. As shown, the score grew from 0 to 30 in the first session, from 30 to 60 in the second session, from 45 to 80 in the third session, and then 70 to 90 in the fourth session, leading to a conversion. As discussed above, the score for conversion factors in time of the sessions, as well as the time between the sessions, which can lead to a decline in the score as the time between sessions increase. The decline of the scores from the end of session two to the beginning of session three and the end of session three to the beginning of session four illustrate this trait.

Once the score change for each session has been determined, the flexible attribution application 320 can then determine the proportion of the conversion that should attributed to each session. In an aspect, the proportion per session is determined by dividing the score change for the given session by the sum of all the score changes for all the sessions. Such a step takes into account the score decline caused by the time delay between sessions. Table 5 below shows the proportion of the conversion that is attributed/credit to each session.

TABLE 5
Score Change over Sessions

| Session | Entry | Exit | Score Change | Session Credit |
|---|---|---|---|---|
| Session 1 | 0 | 30 | 30 | 26.1% |
| Session 2 | 30 | 60 | 30 | 26.1% |
| Session 3 | 45 | 80 | 35 | 30.4% |
| Session 4 | 70 | 90 | 20 | 17.4% |
| Cumulative | | | 115 | |
| Score Change | | | | |

As shown in Table 5, the credit attributable to session one is determined by taking the score change for the session (30−0=30) divided by the total score change (30+30+35+20), which equals 26.1% (30/115). The same process is done for the remaining sessions, resulting in the credit distributions shown above.

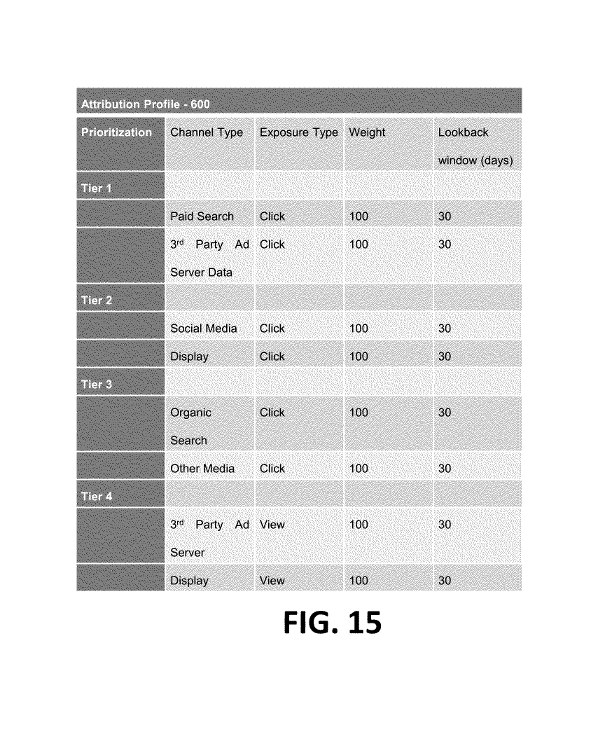

Once the credit distribution per session has been determined, the flexible attribution application 320 can then further distribute the credit to the appropriate exposure/channel. In an aspect, the flexible attribution application 320 can utilize an attribution profile 600 to assist in determining the attribution for each channel. The attribution profile 600 can set the parameters for each channel. Such parameters include, but are not limited to, channel prioritization, exposure type, conversion weight, and time frame, as shown in FIG. 15.

The channel prioritization allows an administrator to prioritize or rate channels. For example, an administrator can rank the channels against one another. In another aspect, the channels can be grouped together in tiers, wherein the tiers are given priority over one another. FIG. 15 illustrates four tiers, with the channels in tier one having a higher priority than the channels in tier two, and so forth. In addition, the channels can be prioritized by the type of exposure associated with the channel. Exposure types indicate the user interaction with the channel—that is, did the user of the internet enabled device 20 actively click the channel, or did the user simply view the channel. This way, a channel that is exposed by a click can be valued higher than a channel exposed just through a view. For example, as shown in FIG. 15, a paid search that is exposed by a click can be given a higher priority than a paid search exposed by a view.

The conversion weight can allow the conversion to be adjustable across a scale, ranging from 0% to 100%. The conversion weight can be used to provide a weighted factor to a specific channel. The lookback window (see FIG. 15) sets the time frame for the actions/sessions that are taken into consideration on a channel, a single on site session being matched to a single exposure. The attribution sequence will be restricted by the lookback window assigned in the cookie. Exposures that are outside that lookback window will not be included in the attribution sequence and thus would not be eligible.

Once the ranking, lookback window, and conversion weight are applied, the ranking or prioritization of the channel/exposure combination allows an administrator to determine how attribution will be distributed amongst the channels within a session. In an aspect, the administrator can set up the prioritization such that the highest prioritized channel, or the highest ranked tier, present in a session receive all of the credits. In another aspect, the ranking can lead to credit being distributed on a percentage basis, with the highest ranked channel or tier getting a higher percentage than the remaining channels or tiers that are present. In aspects utilizing tier rankings, the administrator can also set up various distributions amongst the channel and exposure combinations of the tiers. For example, if multiple channels/exposures of the same tier are present in a session, attribution can be determined by using a variety of well-known attribution models, including, but not limited to, first exposure, last exposure, even distribution, and front or back-weighted.

To the extent necessary to understand or complete the disclosure of the present invention, all publications, patents, and patent applications mentioned herein are expressly incorporated by reference therein to the same extent as though each were individually so incorporated.

Having thus described exemplary embodiments of the present invention, those skilled in the art will appreciate that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A probability scoring system configured to provide attribution for a user converting on a given website, the probability scoring system comprising:
a) a memory; and
b) a processor configured to:
i) receive actions of the user;
ii) parse out the actions to form segment interests of the user;
iii) generate sessions from the actions;
iv) generate a score from the segment interests and the sessions of the user; and
v) determine channel credit for each channel associated with the segment interests and sessions.

2. The system of claim 1, wherein the processor is further configured to determine channel credit by determining the score change for each session, determining the total score change for all the sessions, and dividing the score change for each session by the total score change to determine a session credit.

3. The system of claim 2, wherein the processor is further configured to generate the channel credit from session credit by identifying the channels utilized in the session and distributing the channel credit from the session credit proportionally.

4. The system of claim 1, wherein the sessions further comprise a sequence of exposures, wherein the processor is further configured to identify channels associated with each exposure.

5. The system of claim 1, wherein the processor is further configured to utilize the time between sessions to determine the score for the segment interests and the sessions of the user.

6. The system of claim 1, wherein the processor is further configured to determine the channel credit based upon channel priority.

7. The system of claim 1, wherein the processor is further configured to determine the channel credit based upon exposure type on the channel.

8. The system of claim 1, wherein the segments are determined by a lookback window.

9. The system of claim 1, wherein the actions comprise events and conversions.

10. The system of claim 1, wherein the processor is further configured to generate the score by determining the probability of a conversion with the segment interest.

11. A method for attributing channel credit to channels leading to a conversion by a user on a website, comprising:
a) generating a score for segment interests and sessions of the user; and
b) determining channel credit for each channel associated with the segment interests and sessions.

12. The method of claim 11, wherein the segment interests and sessions of the user are generated by receiving actions of the user, parsing out the actions to form segment interests of the user, and generating generate sessions from the actions.

13. The method of claim 11, wherein the sessions further comprise a sequence of exposures, and further comprising identifying the channels associated with each exposure in the sessions.

14. The method of claim 11, wherein determining channel credit further comprises determining the score change for each session, determining the total score change for all the sessions, and dividing the score change for each session by the total score change to determine a session credit.

15. The method of claim 14, wherein determining the channel credit further comprises identifying the channels utilized in the session and distributing the channel credit from the session credit proportionally.

16. The method of claim 11, wherein generating a score for segment interests and sessions further comprises utilizing the time between sessions to determine the score for the segment interests and the sessions of the user.
